(19) United States
(12) Patent Application Publication
(10) Pub. No.: US 2026/0176459 A1
(43) Pub. Date: Jun. 25, 2026

(54) POLYMERIZABLE COMPOSITION

(71) Applicant: Resonac Corporation, Minato-ku, Tokyo (JP)

(72) Inventors: Yasuhiko YOSHINARI, Minato-ku, Tokyo (JP); Takashi KAWAMORI, Minato-ku, Tokyo (JP); Toru TANAKA, Minato-ku, Tokyo (JP)

(21) Appl. No.: 19/125,771

(22) PCT Filed: Nov. 10, 2023
(86) PCT No.: PCT/JP2023/040568

§ 371 Date: Apr. 30, 2025

(30) Foreign Application Priority Data
Nov. 14, 2022 (JP) 2022-181854

(51) Int. Cl. C08L 51/08; C08F 283/00

(52) U.S. Cl. CPC C08L 51/08; C08F 283/008

(57) ABSTRACT

A polymerizable composition containing a polymerizable compound, the polymerizable composition containing a photoacid generator and an acid component.

### TECHNICAL FIELD

The present disclosure relates to a polymerizable composition and the like.

### BACKGROUND ART

In recent years, a polymerizable composition has been used for bonding various members in manufacture of various devices. For example, Patent Literature 1 below describes a thermosetting composition containing a polymerizable compound.

### CITATION LIST

### Patent Literature

Patent Literature 1: Japanese Unexamined Patent Publication No. 2014-156522

### SUMMARY OF INVENTION

### Technical Problem

In recent years, in accordance with a reduction in size, high performance, and the like of various devices, there are a case where a polymerizable composition is thermally cured in the vicinity of a member that should not be exposed to high heat, a case where a polymerizable composition in contact with a member that should not be exposed to high heat is thermally cured, and the like. In these cases, from the viewpoint of avoiding deterioration of the member by performing thermal curing at a low temperature, it is required to lower a reaction initiation temperature for the polymerizable composition.

In this regard, the present inventors have found that the reaction initiation temperature during thermal curing may be lowered by thermally curing the polymerizable composition after irradiating the polymerizable composition with light.

An object of one aspect of the present disclosure is to provide a polymerizable composition that has a lower reaction initiation temperature in a case where thermal curing is performed after light irradiation than a reaction initiation temperature in a case where only thermal curing is performed.

### Solution to Problem

The present disclosure relates to the following [1] to [11] and the like in some aspects.
[1] A polymerizable composition containing a polymerizable compound, the polymerizable composition containing a photoacid generator and an acid component.
[2] The polymerizable composition according to [1], in which the photoacid generator includes a boron salt containing a borate anion.
[3] The polymerizable composition according to [2], in which the boron salt further contains a sulfonium cation.
[4] The polymerizable composition according to [3], in which the sulfonium cation has an aryl group bonded to a sulfur atom.
[5] The polymerizable composition according to any one of [1] to [4], in which a content of the photoacid generator is 0.01 to 20.00 mass %.
[6] The polymerizable composition according to any one of [1] to [5], in which the acid component includes a phosphorus compound.
[7] The polymerizable composition according to any one of [1] to [6], in which the acid component includes a phosphorus compound having a P═O(OH) structure.
[8] The polymerizable composition according to any one of [1] to [7], in which a content of the acid component is 0.01 to 10.00 mass %.
[9] The polymerizable composition according to any one of [1] to [8], in which a mass ratio of a content of the acid component with respect to a content of the photoacid generator is 0.01 to 10.00.
[10] The polymerizable composition according to any one of [1] to [9], in which the polymerizable compound includes a (meth)acrylate compound.
[11] The polymerizable composition according to any one of [1] to [10], further containing an organic peroxide.

### Advantageous Effects of Invention

According to one aspect of the present disclosure, it is possible to provide a polymerizable composition that has a lower reaction initiation temperature in a case where thermal curing is performed after light irradiation than a reaction initiation temperature in a case where only thermal curing is performed.

### DESCRIPTION OF EMBODIMENTS

Hereinafter, embodiments of the present disclosure will be described in detail. However, the present disclosure is not limited to the following embodiments.

In the present specification, a numerical range indicated using “to” indicates a range including numerical values described before and after “to” as a minimum value and a maximum value, respectively. “A or more” of a numerical range means A and a range more than A. “A or less” of a numerical range means A and a range less than A. In a numerical range described in stages in the present specification, an upper limit value or a lower limit value of a numerical range of a certain stage can be arbitrarily combined with an upper limit value or a lower limit value of a numerical range of another stage. In a numerical range described in the present specification, an upper limit value or a lower limit value of the numerical range may be replaced with a value shown in Examples. “A or B” may include either A or B, and may include both A and B. Materials exemplified in the present specification can be used alone or in combination of two or more types thereof unless otherwise specified. When a plurality of substances corresponding to each component are present in the composition, the content of each component in the composition means the total amount of the plurality of substances present in the composition unless otherwise specified. The “(meth)acrylate” means at least one of an acrylate and a methacrylate corresponding thereto. The same applies to other similar expressions such as “(meth)acryl”. A content of the (meth)acrylate compound means a total amount of an acrylate compound and a methacrylate compound. The “alkyl group” may be linear, branched, or cyclic unless otherwise specified. The “total mass of the polymerizable composition” is a total mass of a solid content of the polymerizable composition. The solid content of the polymerizable composition refers to a nonvolatile content excluding volatile components (water, an organic solvent, and the like) that can be volatilized. That is, the solid content refers to a component that remains without being volatilized in drying of the polymerizable composition, and also includes a component in a liquid state, a syrup state, a wax state, or the like at 25° C.

In the present specification, the “weight average molecular weight” can be measured by performing conversion from a calibration curve using standard polystyrene by gel permeation chromatography (GPC) under the following measurement conditions.

### (Measurement Conditions)

Device: GPC-8020 manufactured by Tosoh Corporation
Detector: RI-8020 manufactured by Tosoh Corporation
Column: Gelpack GL-A-160-S+GL-A150 manufactured by

### Showa Denko Materials Co., Ltd.

Sample concentration: 120 mg/3 mL
Solvent: Tetrahydrofuran
Injection amount: 60 μL
Pressure: 294×10⁶ Pa (30 kgf/cm²)
Flow rate: 1.00 mL/min

A polymerizable composition of the present embodiment is a polymerizable composition containing a polymerizable compound, the polymerizable composition containing (A) a photoacid generator (hereinafter, referred to as “component (A)” in some cases) and (B) an acid component (hereinafter, referred to as “component (B)” in some cases).

The polymerizable composition of the present embodiment contains at least one polymerizable compound, and as a polymerizable compound, may contain at least one selected from the group consisting of the component (A) and the component (B), and may contain a polymerizable compound that does not correspond to at least one selected from the group consisting of the component (A) and the component (B). In a case where at least one selected from the group consisting of the component (A) and the component (B) is a polymerizable compound, the polymerizable composition of the present embodiment may contain a polymerizable compound that does not correspond to at least one selected from the group consisting of the component (A) and the component (B).

The polymerizable composition of the present embodiment can be used as a thermosetting polymerizable composition. According to the polymerizable composition of the present embodiment, a reaction initiation temperature T2 in a case where thermal curing is performed after light irradiation can be lowered as compared to a reaction initiation temperature T1 in a case where only thermal curing is performed. According to the polymerizable composition of the present embodiment, it is possible to obtain an absolute value of a temperature difference (T2−T1) between the reaction initiation temperature T1 and the reaction initiation temperature T2 of higher than 0° C. (preferably, 1° C. or higher, 3° C. or higher, 5° C. or higher, 8° C. or higher, 9° C. or higher, and the like) in an evaluation method described in Examples described below. It is presumed that, when light irradiation is performed before thermal curing in a state in which the component (A) and the component (B) are used in combination, the amount of energy required to initiate thermal curing is reduced, and thus, the reaction initiation temperature T2 is lowered with respect to the reaction initiation temperature T1. However, the factor for lowering the reaction initiation temperature T2 is not limited to this content.

It is enough that the polymerizable composition of the present embodiment has a property that the reaction initiation temperature in a case where thermal curing is performed after light irradiation is lowered as compared to the reaction initiation temperature in a case where only thermal curing is performed, and the polymerizable composition may be used in a step of performing thermal curing without performing light irradiation in advance, a step of simultaneously performing light irradiation and thermal curing, a step of performing light irradiation after thermal curing, and the like, not limited to the step of performing thermal curing after light irradiation. The use of the polymerizable composition of the present embodiment is not particularly limited, and examples thereof include display devices, semiconductor devices, and members for electronic devices. The polymerizable composition of the present embodiment may be used in a micro LED (Light emitting diode), a micro OLED (Organic light emitting diode), and the like.

The polymerizable composition of the present embodiment contains a photoacid generator as the component (A). The photoacid generator is a collective term for compounds that are decomposed by irradiation with active energy rays to generate an acid, and may be, for example, a compound that is decomposed by irradiation with active energy rays having a wavelength of 150 to 750 nm (such as a wavelength of 250 to 440 nm) to generate an acid.

From the viewpoint of easily lowering the reaction initiation temperature during thermal curing by light irradiation (as compared to the reaction initiation temperature in the case where only thermal curing is performed, the reaction initiation temperature in the case where thermal curing is performed after light irradiation is easier to lower: the same applies hereinafter), the component (A) may include a compound containing a borate anion, and may include a boron salt containing a borate anion (a salt of a borate anion and a counter cation; hereinafter, referred to as “component (a1)”). In the polymerizable composition of the present embodiment, the borate anion may be bonded to a counter cation, and may be free without being bonded to a counter cation.

In the borate anion, the number (the number in one molecule) of boron atoms may be 1 to 4, 1 to 3, or 1 to 2, from the viewpoint of easily lowering the reaction initiation temperature during thermal curing by light irradiation.

From the viewpoint of easily lowering the reaction initiation temperature during thermal curing by light irradiation, the borate anion may have a benzene ring (a substituted or unsubstituted phenyl group) and may have a benzene ring (a substituted or unsubstituted phenyl group) bonded to a boron atom. The borate anion may not have a naphthalene ring.

In the borate anion, the number (the number in one molecule) of benzene rings or the number (the number in one molecule) of benzene rings bonded to the boron atom may be 1 to 4, 2 to 4, or 3 to 4, from the viewpoint of easily lowering the reaction initiation temperature during thermal curing by light irradiation.

The borate anion may have a benzene ring having a substituent. Examples of the substituent include a halogen atom (for example, a fluoro group), an alkyl group, an aryl group, and an alkoxy group. From the viewpoint of easily lowering the reaction initiation temperature during thermal curing by light irradiation, the borate anion may have a benzene ring substituted with a fluoro group and may have a benzene ring substituted with five fluoro groups.

Examples of the borate anion include (C₆F₅)₄B⁻ (tetrakispentafluorophenylborate anion), (C₆F₅)₃(C₆H₅)B⁻, (C₆F₅)₂(C₆H₅)₂B⁻, (C₆F₅)(C₆H₅)₃B⁻, and (CN)₄B⁻.

Examples of the counter cation of the component (a1) include a sulfonium cation, a quaternary ammonium ion, a tertiary ammonium ion, a secondary ammonium ion, a primary ammonium ion, an ammonium ion, an imidazolium ion, an imidazolinium ion, a pyridinium ion, an alkali metal ion (a sodium ion, a potassium ion, and the like), a phosphonium cation, and an iodonium cation. The component (a1) may not contain a metal ion and may contain a metal ion. Examples of the metal ion include an alkali metal ion (a sodium ion, a potassium ion, and the like). The component (a1) may contain a sulfonium cation as the counter cation from the viewpoint of easily lowering the reaction initiation temperature during thermal curing by light irradiation.

From the viewpoint of easily lowering the reaction initiation temperature during thermal curing by light irradiation, the component (A) may include a compound containing a sulfonium cation, and may contain a salt containing sulfonium cation (a salt of a sulfonium cation and a counter anion, hereinafter, referred to as “component (a2)”). In the polymerizable composition of the present embodiment, the sulfonium cation may be bonded to a counter anion, and may be free without being bonded to a counter anion. Examples of the counter anion include a borate anion (for example, various borate anions having the above-mentioned features with respect to the component (a1)), SbF₆⁻, AsF₆⁻, PF₆⁻, CH₃SO₃⁻, and CF₃SO₃⁻. The component (a2) may contain a borate anion as the counter anion from the viewpoint of easily lowering the reaction initiation temperature during thermal curing by light irradiation.

Examples of the substituent bonded to the sulfur atom (the positively charged sulfur atom) in the sulfonium cation of the component (a1) or the component (a2) include an alkyl group and an aryl group. Examples of the aryl group include a substituted or unsubstituted phenyl group, a substituted or unsubstituted biphenyl group, and a substituted or unsubstituted thioxanthone group. The substituted phenyl group does not encompass a substituted or unsubstituted biphenyl group. The substituent bonded to the sulfur atom (the positively charged sulfur atom) may be a substituent containing a sulfur atom (a sulfur atom different from the positively charged sulfur atom).

The sulfonium cation of the component (a1) or the component (a2) may have an aryl group bonded to a sulfur atom (a positively charged sulfur atom) from the viewpoint of easily lowering the reaction initiation temperature during thermal curing by light irradiation. In the sulfonium cation, the number (the number in one molecule) of aryl groups bonded to the sulfur atom (the positively charged sulfur atom) may be 1 to 3 or 2 to 3 from the viewpoint of easily lowering the reaction initiation temperature during thermal curing by light irradiation. In the sulfonium cation, the number (the number in one molecule) of substituted or unsubstituted phenyl groups bonded to the sulfur atom (the positively charged sulfur atom) may be 1 to 3, 1 to 2, or 2 to 3, from the viewpoint of easily lowering the reaction initiation temperature during thermal curing by light irradiation.

From the viewpoint of easily lowering the reaction initiation temperature during thermal curing by light irradiation, the sulfonium cation of the component (a1) or the component (a2) may have a substituted or unsubstituted phenyl group, may have a substituted or unsubstituted biphenyl group, and may have a substituted or unsubstituted thioxanthone group, as an aryl group bonded to a sulfur atom (a positively charged sulfur atom). From the viewpoint of easily lowering the reaction initiation temperature during thermal curing by light irradiation, the phenyl group bonded to the sulfur atom (the positively charged sulfur atom) may be substituted with a sulfur atom (a sulfur atom different from the positively charged sulfur atom), and may be bonded to an aryl group (a substituted or unsubstituted phenyl group, a substituted or unsubstituted biphenyl group, a substituted or unsubstituted thioxanthone group, or the like) via this sulfur atom.

A content of the component (a1) or a content of the component (a2) may be 50.00 mass % or more, more than 50.00 mass %, 70.00 mass % or more, 80.00 mass % or more, 90.00 mass % or more, 92.00 mass % or more, 95.00 mass % or more, 97.00 mass % or more, 98.00 mass % or more, 99.00 mass % or more, or substantially 100.00 mass %, based on the total mass of the component (A), from the viewpoint of easily lowering the reaction initiation temperature during thermal curing by light irradiation.

A content of the component (A) may be in the following range based on the total mass of the polymerizable composition. The content of the component (A) may be 0.01 mass % or more, 0.05 mass % or more, 0.10 mass % or more, 0.20 mass % or more, 0.30 mass % or more, 0.35 mass % or more, 0.40 mass % or more, 0.45 mass % or more, 0.50 mass % or more, 0.55 mass % or more, 0.60 mass % or more, 0.65 mass % or more, 0.70 mass % or more, 0.80 mass % or more, 1.00 mass % or more, 1.20 mass % or more, 1.50 mass % or more, 1.60 mass % or more, 1.80 mass % or more, or 1.90 mass % or more, from the viewpoint of easily lowering the reaction initiation temperature during thermal curing by light irradiation. The content of the component (A) may be 20.00 mass % or less, 15.00 mass % or less, 10.00 mass % or less, 8.00 mass % or less, 6.00 mass % or less, 5.00 mass % or less, 4.00 mass % or less, 3.00 mass % or less, 2.50 mass % or less, 2.20 mass % or less, or 2.00 mass % or less, from the viewpoint of easily lowering the reaction initiation temperature during thermal curing by light irradiation. The content of the component (A) may be 1.90 mass % or less, 1.80 mass % or less, 1.50 mass % or less, 1.20 mass % or less, 1.00 mass % or less, 0.80 mass % or less, 0.70 mass % or less, 0.65 mass % or less, 0.60 mass % or less, 0.55 mass % or less, or 0.50 mass % or less. From these viewpoints, the content of the component (A) may be 0.01 to 20.00 mass %, 0.30 to 20.00 mass %, 1.00 to 20.00 mass %, 0.01 to 5.00 mass %, 0.30 to 5.00 mass %, 1.00 to 5.00 mass %, 0.01 to 3.00 mass %, 0.30 to 3.00 mass %, 1.00 to 3.00 mass %, 0.01 to 1.00 mass %, or 0.30 to 1.00 mass %.

The polymerizable composition of the present embodiment contains an acid component (with the proviso that the compound corresponding to the component (A) is excluded) as the component (B). As the component (B), at least one selected from the group consisting of an acid and an acid derivative can be used. Examples of the acid include an inorganic acid and an organic acid. Examples of the inorganic acid include phosphoric acid, hydrochloric acid, nitric acid, and sulfuric acid. Examples of the organic acid include a carboxylic acid and a sulfonic acid. Examples of the acid derivative include a salt, an anhydride, and an ester.

From the viewpoint of easily lowering the reaction initiation temperature during thermal curing by light irradiation, the component (B) may include a phosphorus compound (a compound containing a phosphorus atom), may include a phosphorus compound having a P—OH structure, and may include a phosphorus compound having a P═O(OH) structure (hereinafter, referred to as “component (b1)”). In the component (b1), as shown in the General Formula (b1) below, an oxygen atom is bonded to a phosphorus atom via a double bond, and a hydroxy group is bonded to this phosphorus atom via a single bond. In the component (b1), the number (number in one molecule) of P═O(OH) structures may be one.

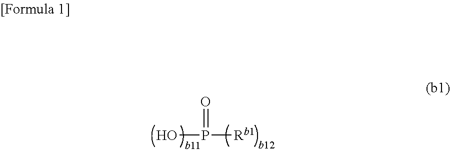

[In the formula, b11 represents an integer of 1 to 3, b12 represents an integer of 0 to 2, b11+b12 is 3, and R^{b1} represents a monovalent group.]

b11 may be 1 to 2 or 2 to 3 from the viewpoint of easily lowering the reaction initiation temperature during thermal curing by light irradiation.

The component (b1) may have a monovalent group (R^{b1} of General Formula (b1)) different from a hydroxy group as a functional group bonded to a phosphorus atom. Examples of the monovalent group include a substituted or unsubstituted alkyl group, a substituted or unsubstituted aryl group (for example, a phenyl group), and a group having (meth)acryloyl group. The group having (meth)acryloyl group is a group having at least one selected from the group consisting of an acryloyl group and a methacryloyl group.

From the viewpoint of easily lowering the reaction initiation temperature during thermal curing by light irradiation, the component (b1) may include at least one selected from the group consisting of a (meth)acrylate compound having a P═O(OH) structure, phosphoric acid, and phenylphosphonic acid, may include a (meth)acrylate compound having a P═O(OH) structure, and may include a compound represented by the General Formula (b2) below.

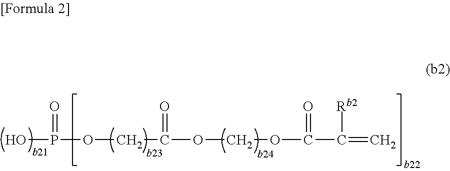

[In the formula, b21 represents an integer of 1 or 2, b22 represents an integer of 1 or 2, b21+b22 is 3, b23 and b24 each independently represent an integer of 1 or more, and R^{b2} represents a hydrogen atom or a methyl group.]

b23 may be 1 to 8, 1 to 6, 1 to 5, 3 to 8, 3 to 6, 3 to 5, 5 to 8, or 5 to 6, from the viewpoint of easily lowering the reaction initiation temperature during thermal curing by light irradiation. b24 may be 1 to 4, 2 to 4, 1 to 3, or 1 to 2, from the viewpoint of easily lowering the reaction initiation temperature during thermal curing by light irradiation.

The component (B) may include at least one organic acid component selected from the group consisting of an organic acid and an organic acid derivative. The component (B) may include, as the organic acid component, at least one selected from the group consisting of an aliphatic carboxylic acid, a salt of an aliphatic carboxylic acid, and a hydrate of an aliphatic carboxylic acid, and may include at least one selected from the group consisting of an aliphatic carboxylic acid having at least one selected from the group consisting of a hydroxy group and an ether group, a salt of such aliphatic carboxylic acid, and a hydrate of such aliphatic carboxylic acid. Examples of the aliphatic carboxylic acid include a hydroxy acid such as malic acid, citric acid, glycolic acid, tartaric acid, lactic acid, glyceric acid, hydroxybutyric acid, and tartronic acid; an ether-based dicarboxylic acid (dicarboxylic acid having an ether group) such as diglycolic acid; and an alkoxyacetic acid such as methoxyacetic acid and ethoxyacetic acid. The component (B) may include, as the organic acid component, at least one selected from the group consisting of an aromatic carboxylic acid, a salt of an aromatic carboxylic acid, and a hydrate of an aromatic carboxylic acid, and may include at least one selected from the group consisting of an aromatic carboxylic acid having two or more hydroxy groups, a salt of such aromatic carboxylic acid, and a hydrate of such aromatic carboxylic acid. Examples of the aromatic carboxylic acid include protocatechuic acid, α-resorcylic acid, β-resorcylic acid, γ-resorcylic acid, 2-pyrocatechuic acid, gentisic acid, orsellinic acid, gallic acid, and phloroglucinol carboxylic acid. Examples of the other organic acid components include phthalic anhydride, maleic anhydride, trimellitic anhydride, hexahydrophthalic anhydride, tetrahydrophthalic anhydride, methylnadic anhydride, nadic anhydride, glutaric anhydride, dimethylglutaric anhydride, diethylglutaric anhydride, succinic anhydride, methylhexahydrophthalic anhydride, methyltetrahydrophthalic anhydride, 1,2,3,4-cyclobutanetetracarboxylic dianhydride, 4,4′-biphthalic anhydride, 4,4′-carbonyldiphthalic anhydride, 4,4′-sulfonyldiphthalic anhydride, 4,4′-(hexafluoroisopropylidene)diphthalic anhydride, 4,4′-oxydiphthalic anhydride, 9,9-bis(3,4-dicarboxyphenyl) fluorene dianhydride, and 2,3,6,7-naphthalenetetracarboxylic dianhydride.

A content of the component (b1) may be 50.00 mass % or more, more than 50.00 mass %, 70.00 mass % or more, 80.00 mass % or more, 90.00 mass % or more, 92.00 mass % or more, 95.00 mass % or more, 97.00 mass % or more, 98.00 mass % or more, 99.00 mass % or more, or substantially 100.00 mass %, based on the total mass of the component (B) or a phosphorus compound (a phosphorus compound corresponding to the component (B)) contained in the polymerizable composition, from the viewpoint of easily lowering the reaction initiation temperature during thermal curing by light irradiation.

A content of the component (B) may be in the following range based on the total mass of the polymerizable composition from the viewpoint of easily lowering the reaction initiation temperature during thermal curing by light irradiation. The content of the component (B) may be 0.01 mass % or more, 0.05 mass % or more, 0.10 mass % or more, 0.20 mass % or more, 0.30 mass % or more, 0.40 mass % or more, 0.50 mass % or more, 0.60 mass % or more, 0.70 mass % or more, 0.80 mass % or more, or 0.90 mass % or more. The content of the component (B) may be 10.00 mass % or less, 8.00 mass % or less, 6.00 mass % or less, 5.00 mass % or less, 4.00 mass % or less, 3.00 mass % or less, 2.00 mass % or less, or 1.00 mass % or less. From these viewpoints, the content of the component (B) may be 0.01 to 10.00 mass %, 0.01 to 2.00 mass %, 0.01 to 1.00 mass %, 0.10 to 10.00 mass %, 0.10 to 2.00 mass %, 0.10 to 1.00 mass %, 0.30 to 10.00 mass %, 0.30 to 2.00 mass %, or 0.30 to 1.00 mass %.

A mass ratio R1 of the content of the component (B) with respect to the content of the component (A) (component (B)/component (A)) may be in the following range. The mass ratio R1 may be 0.01 or more, 0.05 or more, 0.10 or more, 0.15 or more, 0.20 or more, 0.25 or more, 0.30 or more, 0.35 or more, 0.40 or more, or 0.45 or more, from the viewpoint of easily lowering the reaction initiation temperature during thermal curing by light irradiation. The mass ratio R1 may be 0.50 or more, 0.60 or more, 0.70 or more, 0.80 or more, 0.90 or more, 1.00 or more, 1.20 or more, 1.50 or more, or 1.80 or more. The mass ratio R1 may be 10.00 or less, 8.00 or less, 6.00 or less, 5.00 or less, 4.00 or less, 3.00 or less, 2.00 or less, 1.80 or less, 1.50 or less, 1.20 or less, 1.00 or less, 0.90 or less, 0.80 or less, 0.70 or less, 0.60 or less, or 0.50 or less, from the viewpoint of easily lowering the reaction initiation temperature during thermal curing by light irradiation. From these viewpoints, the mass ratio R1 may be 0.01 to 10.00, 0.01 to 3.00, 0.01 to 1.00, 0.10 to 10.00, 0.10 to 3.00, 0.10 to 1.00, 0.50 to 10.00, or 0.50 to 3.00.

The polymerizable composition of the present embodiment may contain a polymerizable compound (with the proviso that a compound corresponding to the component (A) or the component (B) is excluded) as a component (C).

Examples of the component (C) include a radical polymerizable compound, a cationic polymerizable compound, and an anionic polymerizable compound. The component (C) may include a radical polymerizable compound from the viewpoint of easily lowering the reaction initiation temperature during thermal curing by light irradiation. In the polymerizable composition of the present embodiment, a photoacid generator can be used in a radical curing system using a radical polymerizable compound.

Examples of the component (C) include a (meth)acrylate compound, a maleimide compound, a vinyl ether compound, an allyl compound, a styrene compound, a (meth)acrylamide compound, a nadi-imide compound, natural rubber, isoprene rubber, butyl rubber, nitrile rubber, butadiene rubber, styrene-butadiene rubber, acrylonitrile-butadiene rubber, carboxylated nitrile rubber, an epoxy compound, an oxetane compound, and a lactone compound. From the viewpoint of easily lowering the reaction initiation temperature during thermal curing by light irradiation, the component (C) may include a compound having an ethylenically unsaturated bond and may include a (meth)acrylate compound.

Examples of the (meth)acrylate compound include (poly)urethane (meth)acrylate, epoxy (meth)acrylate, methyl (meth)acrylate, polyether (meth)acrylate, polyester (meth)acrylate, polybutadiene (meth)acrylate, silicone (meth)acrylate, ethyl (meth)acrylate, 2-cyanoethyl (meth)acrylate, 2-(2-ethoxyethoxy)ethyl (meth)acrylate, 2-ethoxyethyl (meth)acrylate, 2-ethylhexyl (meth)acrylate, n-hexyl (meth)acrylate, 2-hydroxyethyl (meth)acrylate, isopropyl (meth)acrylate, hydroxypropyl (meth)acrylate, isobutyl (meth)acrylate, isobornyl (meth)acrylate, isodecyl (meth)acrylate, isooctyl (meth)acrylate, n-lauryl (meth)acrylate, 2-methoxyethyl (meth)acrylate, 2-phenoxyethyl (meth)acrylate, tetrahydrofurfuryl (meth)acrylate, N,N-dimethylaminoethyl (meth)acrylate, N,N-dimethylaminopropyl (meth)acrylate, ethylene glycol di(meth)acrylate, diethylene glycol di(meth)acrylate, trimethylolpropane tri(meth)acrylate, tetramethylolmethane tetra(meth)acrylate, polyethylene glycol di(meth)acrylate, polyalkylene glycol di(meth)acrylate, cyclohexyl (meth)acrylate, dicyclopentenyl (meth)acrylate, dicyclopentenyloxyethyl (meth)acrylate, neopentyl glycol di(meth)acrylate, pentaerythritol (meth)acrylate, dipentaerythritol hexa(meth)acrylate, isocyanuric acid alkylene oxide modified di(meth)acrylate, isocyanuric acid alkylene oxide modified tri(meth)acrylate, tricyclodecanyl(meth)acrylate, dimethyloltricyclodecane di(meth)acrylate, 2-hydroxy-1,3-di(meth)acryloxypropane, 2,2-bis[4-((meth)acryloxymethoxy)phenyl]propane, and 2,2-bis[4-((meth)acryloxypolyethoxy)phenyl]propane. “Polyurethane (meth)acrylate” and “urethane (meth)acrylate” are collectively referred to as “(poly)urethane (meth)acrylate”. The component (C) may include a bifunctional (meth)acrylate compound from the viewpoint of easily lowering the reaction initiation temperature during thermal curing by light irradiation.

From the viewpoint of easily lowering the reaction initiation temperature during thermal curing by light irradiation, the component (C) may include a urethane (meth)acrylate compound having a polycarbonate skeleton (hereinafter, referred to as “component (c1)”), may include a urethane (meth)acrylate compound having a structure derived from polycarbonate polyol, and may include a compound represented by the General Formula (c1) below.

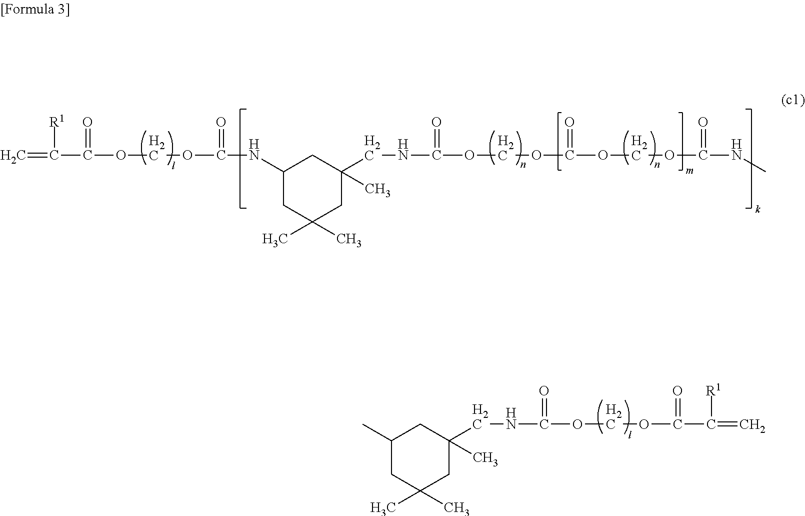

[In the formula, R¹ represents a hydrogen atom or a methyl group, j represents an integer of 1 to 3, k represents an integer of 2 to 7, m represents an integer of 1 to 8, and n represents an integer of 5 to 7.]

In General Formula (c1), from the viewpoint of easily lowering the reaction initiation temperature during thermal curing by light irradiation, j may be 1 to 2 or 2 to 3, k may be 2 to 3 or 3 to 5, m may be 1 to 6, 1 to 4, or 1 to 2, and n may be 5 to 6 or 6 to 7.

A weight average molecular weight of the component (c1) may be 1000 or more, 3000 or more, 5000 or more, 8000 or more, 10000 or more, 12000 or more, 13000 or more, 14000 or more, or 15000 or more, from the viewpoint of easily lowering the reaction initiation temperature during thermal curing by light irradiation. The weight average molecular weight of the component (c1) may be 100000 or less, 50000 or less, 30000 or less, 25000 or less, 20000 or less, 18000 or less, or 15000 or less, from the viewpoint of easily lowering the reaction initiation temperature during thermal curing by light irradiation. From these viewpoints, the weight average molecular weight of the component (c1) may be 1000 to 100000, 5000 to 50000, or 10000 to 30000.

A content of the component (c1) may be in the following range based on the total mass of the component (C) from the viewpoint of easily lowering the reaction initiation temperature during thermal curing by light irradiation. The content of the component (c1) may be 10.00 mass % or more, 15.00 mass % or more, 20.00 mass % or more, 25.00 mass % or more, 30.00 mass % or more, 35.00 mass % or more, 40.00 mass % or more, 45.00 mass % or more, 50.00 mass % or more, or 55.00 mass % or more. The content of the component (c1) may be 90.00 mass % or less, 85.00 mass % or less, 80.00 mass % or less, 75.00 mass % or less, 70.00 mass % or less, 65.00 mass % or less, or 60.00 mass % or less. From these viewpoints, the content of the component (c1) may be 10.00 to 90.00 mass %, 10.00 to 80.00 mass %, 10.00 to 70.00 mass %, 20.00 to 90.00 mass %, 20.00 to 80.00 mass %, 20.00 to 70.00 mass %, 40.00 to 90.00 mass %, 40.00 to 80.00 mass %, or 40.00 to 70.00 mass %.

The content of the component (c1) may be in the following range based on the total mass of the polymerizable composition from the viewpoint of easily lowering the reaction initiation temperature during thermal curing by light irradiation. The content of the component (c1) may be 5.00 mass % or more, 10.00 mass % or more, 15.00 mass % or more, or 20.00 mass % or more. The content of the component (c1) may be 50.00 mass % or less, 45.00 mass % or less, 40.00 mass % or less, 35.00 mass % or less, 30.00 mass % or less, or 25.00 mass % or less. From these viewpoints, the content of the component (c1) may be 5.00 to 50.00 mass %, 5.00 to 40.00 mass %, 5.00 to 30.00 mass %, 10.00 to 50.00 mass %, 10.00 to 40.00 mass %, 10.00 to 30.00 mass %, 20.00 to 50.00 mass %, 20.00 to 40.00 mass %, or 20.00 to 30.00 mass %.

From the viewpoint of easily lowering the reaction initiation temperature during thermal curing by light irradiation, the component (C) may include an isocyanuric acid alkylene oxide-modified di(meth)acrylate (excluding a compound corresponding to the component (c1); hereinafter, referred to as “component (c2)”), and may include an isocyanuric acid ethylene oxide-modified di(meth)acrylate.

A content of the component (c2) may be in the following range based on the total mass of the component (C) from the viewpoint of easily lowering the reaction initiation temperature during thermal curing by light irradiation. The content of the component (c2) may be 1.00 mass % or more, 5.00 mass % or more, 10.00 mass % or more, 15.00 mass % or more, or 20.00 mass % or more. The content of the component (c2) may be 50.00 mass % or less, 45.00 mass % or less, 40.00 mass % or less, 35.00 mass % or less, 30.00 mass % or less, or 25.00 mass % or less. From these viewpoints, the content of the component (c2) may be 1.00 to 50.00 mass %, 1.00 to 40.00 mass %, 1.00 to 30.00 mass %, 10.00 to 50.00 mass %, 10.00 to 40.00 mass %, 10.00 to 30.00 mass %, 20.00 to 50.00 mass %, 20.00 to 40.00 mass %, or 20.00 to 30.00 mass %.

The content of the component (c2) may be in the following range based on the total mass of the polymerizable composition from the viewpoint of easily lowering the reaction initiation temperature during thermal curing by light irradiation. The content of the component (c2) may be 1.00 mass % or more, 3.00 mass % or more, 5.00 mass % or more, 7.00 mass % or more, 8.00 mass % or more, or 9.00 mass % or more. The content of the component (c2) may be 30.00 mass % or less, 25.00 mass % or less, 20.00 mass % or less, 15.00 mass % or less, or 10.00 mass % or less. From these viewpoints, the content of the component (c2) may be 1.00 to 30.00 mass %, 1.00 to 20.00 mass %, 1.00 to 10.00 mass %, 5.00 to 30.00 mass %, 5.00 to 20.00 mass %, 5.00 to 10.00 mass %, 7.00 to 30.00 mass %, 7.00 to 20.00 mass %, or 7.00 to 10.00 mass %.

From the viewpoint of easily lowering the reaction initiation temperature during thermal curing by light irradiation, the component (C) may include a di(meth)acrylate compound (excluding a compound corresponding to the component (c1) or the component (c2); hereinafter, referred to as “component (c3)”) having at least one selected from the group consisting of a dicyclopentanyl structure and a dicyclopentenyl structure, and may include at least one selected from the group consisting of dimethyloltricyclodecane di(meth)acrylate and tricyclodecanediol di(meth)acrylate.

A content of the component (c3) may be in the following range based on the total mass of the component (C) from the viewpoint of easily lowering the reaction initiation temperature during thermal curing by light irradiation. The content of the component (c3) may be 1.00 mass % or more, 5.00 mass % or more, 10.00 mass % or more, 15.00 mass % or more, or 20.00 mass % or more. The content of the component (c3) may be 50.00 mass % or less, 45.00 mass % or less, 40.00 mass % or less, 35.00 mass % or less, 30.00 mass % or less, or 25.00 mass % or less. From these viewpoints, the content of the component (c3) may be 1.00 to 50.00 mass %, 1.00 to 40.00 mass %, 1.00 to 30.00 mass %, 10.00 to 50.00 mass %, 10.00 to 40.00 mass %, 10.00 to 30.00 mass %, 20.00 to 50.00 mass %, 20.00 to 40.00 mass %, or 20.00 to 30.00 mass %.

The content of the component (c3) may be in the following range based on the total mass of the polymerizable composition from the viewpoint of easily lowering the reaction initiation temperature during thermal curing by light irradiation. The content of the component (c3) may be 1.00 mass % or more, 3.00 mass % or more, 5.00 mass % or more, 7.00 mass % or more, 8.00 mass % or more, or 9.00 mass % or more. The content of the component (c3) may be 30.00 mass % or less, 25.00 mass % or less, 20.00 mass % or less, 15.00 mass % or less, or 10.00 mass % or less. From these viewpoints, the content of the component (c3) may be 1.00 to 30.00 mass %, 1.00 to 20.00 mass %, 1.00 to 10.00 mass %, 5.00 to 30.00 mass %, 5.00 to 20.00 mass %, 5.00 to 10.00 mass %, 7.00 to 30.00 mass %, 7.00 to 20.00 mass %, or 7.00 to 10.00 mass %.

A content of the component (C) may be in the following range based on the total mass of the polymerizable composition from the viewpoint of easily lowering the reaction initiation temperature during thermal curing by light irradiation. The content of the component (C) may be 10.00 mass % or more, 15.00 mass % or more, 20.00 mass % or more, 25.00 mass % or more, 30.00 mass % or more, 35.00 mass % or more, 38.00 mass % or more, or 40.00 mass % or more. The content of the component (C) may be 80.00 mass % or less, 75.00 mass % or less, 70.00 mass % or less, 65.00 mass % or less, 60.00 mass % or less, 55.00 mass % or less, 50.00 mass % or less, 45.00 mass % or less, or 43.00 mass % or less. From these viewpoints, the content of the component (C) may be 10.00 to 80.00 mass %, 10.00 to 60.00 mass %, 10.00 to 50.00 mass %, 30.00 to 80.00 mass %, 30.00 to 60.00 mass %, 30.00 to 50.00 mass %, 35.00 to 80.00 mass %, 35.00 to 60.00 mass %, or 35.00 to 50.00 mass %.

A mass ratio R2 of the content of the component (C) with respect to the content of the component (A) (component (C)/component (A)) may be in the following range. The mass ratio R2 may be 1.00 or more, 5.00 or more, 10.00 or more, 15.00 or more, or 20.00 or more, from the viewpoint of easily lowering the reaction initiation temperature during thermal curing by light irradiation. The mass ratio R2 may be 25.00 or more, 30.00 or more, 40.00 or more, 50.00 or more, 60.00 or more, 70.00 or more, or 80.00 or more. The mass ratio R2 may be 300.00 or less, 250.00 or less, 200.00 or less, 150.00 or less, 120.00 or less, 100.00 or less, 90.00 or less, 85.00 or less, 80.00 or less, 70.00 or less, 60.00 or less, 50.00 or less, 40.00 or less, 30.00 or less, or 25.00 or less, from the viewpoint of easily lowering the reaction initiation temperature during thermal curing by light irradiation. From these viewpoints, the mass ratio R2 may be 1.00 to 300.00, 1.00 to 120.00, 1.00 to 50.00, 10.00 to 300.00, 10.00 to 120.00, 10.00 to 50.00, 30.00 to 300.00, or 30.00 to 120.00.

A mass ratio R3 of the content of the component (C) with respect to the content of the component (B) (component (C)/component (B)) may be in the following range from the viewpoint of easily lowering the reaction initiation temperature during thermal curing by light irradiation. The mass ratio R3 may be 1.00 or more, 5.00 or more, 10.00 or more, 15.00 or more, 20.00 or more, 25.00 or more, 30.00 or more, 35.00 or more, 40.00 or more, or 45.00 or more. The mass ratio R3 may be 500.00 or less, 450.00 or less, 400.00 or less, 350.00 or less, 300.00 or less, 250.00 or less, 200.00 or less, 180.00 or less, 150.00 or less, 120.00 or less, 100.00 or less, 80.00 or less, 60.00 or less, or 50.00 or less. From these viewpoints, the mass ratio R3 may be 1.00 to 500.00, 1.00 to 100.00, 1.00 to 50.00, 10.00 to 500.00, 10.00 to 100.00, 10.00 to 50.00, 30.00 to 500.00, 30.00 to 100.00, or 30.00 to 50.00.

The polymerizable composition of the present embodiment may contain a polymerization initiator (with the proviso that a compound corresponding to the component (A), the component (B), or the component (C) is excluded) as a component (D). The component (D) may include a thermal polymerization initiator. Examples of the component (D) include a radical polymerization initiator, a cationic polymerization initiator, and an anionic polymerization initiator. The component (D) may include a radical polymerization initiator from the viewpoint of easily lowering the reaction initiation temperature during thermal curing by light irradiation. In the polymerizable composition of the present embodiment, a photoacid generator can be used in a radical curing system using a radical polymerization initiator.

Examples of the component (D) include ketone peroxides such as methyl ethyl ketone peroxide, cyclohexanone peroxide, and methylcyclohexanone peroxide; peroxyketals such as 1,1-bis(tert-butylperoxy)cyclohexane, 1,1-bis(tert-butylperoxy)-2-methylcyclohexane, 1,1-bis(tert-butylperoxy)-3,3,5-trimethylcyclohexane, 1,1-bis(tert-hexylperoxy)cyclohexane, and 1,1-bis(tert-hexylperoxy)-3,3,5-trimethylcyclohexane; hydroperoxides such as p-menthane hydroperoxide; dialkyl peroxides such as α,α′-bis(tert-butylperoxy) diisopropylbenzene, dicumyl peroxide, tert-butylcumyl peroxide, and di-tert-butyl peroxide; diacyl peroxides such as octanoyl peroxide, lauroyl peroxide, stearyl peroxide, and benzoyl peroxide; peroxycarbonates such as bis(4-tert-butylcyclohexyl) peroxydicarbonate, di-2-ethoxyethyl peroxydicarbonate, di-2-ethylhexyl peroxydicarbonate, and di-3-methoxybutyl peroxydicarbonate; peroxy esters such as tert-butyl peroxypivalate, tert-hexyl peroxypivalate, 1,1,3,3-tetramethylbutylperoxy-2-ethylhexanoate, 2,5-dimethyl-2,5-bis(2-ethylhexanoylperoxy) hexane, tert-hexylperoxy-2-ethylhexanoate, tert-butylperoxy-2-ethylhexanoate, tert-butyl peroxyisobutyrate, tert-hexyl peroxyisopropyl monocarbonate, tert-butyl peroxy-3,5,5-trimethylhexanoate, tert-butyl peroxylaurate, tert-butyl peroxyisopropyl monocarbonate, tert-butylperoxy-2-ethylhexyl monocarbonate, tert-butyl peroxybenzoate, tert-hexyl peroxybenzoate, 2,5-dimethyl-2,5-bis(benzoylperoxy) hexane, and tert-butyl peroxyacetate; azo compounds such as 2,2′-azobisisobutyronitrile, 2,2′-azobis(2,4-dimethylvaleronitrile), and 2,2′-azobis(4-methoxy-2′-dimethylvaleronitrile); iodonium salts; sulfonium salts; phosphonium salts; and imidazole compounds.

From the viewpoint of easily lowering the reaction initiation temperature during thermal curing by light irradiation, the polymerizable composition of the present embodiment may contain a peroxide, may contain an organic peroxide, and may contain a diacyl peroxide, as the component (D).

A content of the component (D) may be in the following range based on the total mass of the polymerizable composition from the viewpoint of easily lowering the reaction initiation temperature during thermal curing by light irradiation. The content of the component (D) may be 0.10 mass % or more, 0.50 mass % or more, 1.00 mass % or more, 1.50 mass % or more, 2.00 mass % or more, 2.50 mass % or more, 3.00 mass % or more, 3.50 mass % or more, 4.00 mass % or more, or 4.50 mass % or more. The content of the component (D) may be 20.00 mass % or less, 15.00 mass % or less, 10.00 mass % or less, 9.00 mass % or less, 8.00 mass % or less, 7.00 mass % or less, 6.00 mass % or less, or 5.00 mass % or less. From these viewpoints, the content of the component (D) may be 0.10 to 20.00 mass %, 0.10 to 10.00 mass %, 0.10 to 6.00 mass %, 1.00 to 20.00 mass %, 1.00 to 10.00 mass %, 1.00 to 6.00 mass %, 3.00 to 20.00 mass %, 3.00 to 10.00 mass %, or 3.00 to 6.00 mass %.

A mass ratio R4 of the content of the component (D) with respect to the content of the component (A) (component (D)/component (A)) may be in the following range. The mass ratio R4 may be 0.10 or more, 0.50 or more, 1.00 or more, 1.50 or more, or 2.00 or more, from the viewpoint of easily lowering the reaction initiation temperature during thermal curing by light irradiation. The mass ratio R4 may be 2.50 or more, 3.00 or more, 4.00 or more, 5.00 or more, 6.00 or more, 8.00 or more, 8.50 or more, or 9.00 or more. The mass ratio R4 may be 50.00 or less, 30.00 or less, 20.00 or less, 15.00 or less, 12.00 or less, 10.00 or less, 9.00 or less, 8.50 or less, 8.00 or less, 6.00 or less, 5.00 or less, 4.00 or less, 3.00 or less, or 2.50 or less, from the viewpoint of easily lowering the reaction initiation temperature during thermal curing by light irradiation. From these viewpoints, the mass ratio R4 may be 0.10 to 50.00, 0.10 to 15.00, 0.10 to 8.00, 1.00 to 50.00, 1.00 to 15.00, 1.00 to 8.00, 5.00 to 50.00, or 5.00 to 15.00.

A mass ratio R5 of the content of the component (D) with respect to the content of the component (B) (component (D)/component (B)) may be in the following range from the viewpoint of easily lowering the reaction initiation temperature during thermal curing by light irradiation. The mass ratio R5 may be 0.10 or more, 0.50 or more, 1.00 or more, 2.00 or more, 3.00 or more, 4.00 or more, or 5.00 or more. The mass ratio R5 may be 50.00 or less, 30.00 or less, 25.00 or less, 20.00 or less, 18.00 or less, 15.00 or less, 12.00 or less, 10.00 or less, 8.00 or less, 6.00 or less, or 5.00 or less. From these viewpoints, the mass ratio R5 may be 0.10 to 50.00, 0.10 to 30.00, 0.10 to 10.00, 1.00 to 50.00, 1.00 to 30.00, 1.00 to 10.00, 3.00 to 50.00, 3.00 to 30.00, or 3.00 to 10.00.

A mass ratio R6 of the content of the component (D) with respect to the content of the component (C) (component (D)/component (C)) may be in the following range from the viewpoint of easily lowering the reaction initiation temperature during thermal curing by light irradiation. The mass ratio R6 may be 0.01 or more, 0.03 or more, 0.05 or more, 0.08 or more, or 0.10 or more. The mass ratio R6 may be 5.00 or less, 3.00 or less, 1.00 or less, 0.50 or less, 0.30 or less, 0.20 or less, or 0.15 or less. From these viewpoints, the mass ratio R6 may be 0.01 to 5.00, 0.01 to 1.00, 0.01 to 0.50, 0.05 to 5.00, 0.05 to 1.00, 0.05 to 0.50, 0.10 to 5.00, 0.10 to 1.00, or 0.10 to 0.50.

The polymerizable composition of the present embodiment may contain a thermoplastic resin as a component (E).

Examples of the component (E) include a phenoxy resin, polyester, polyurethane (excluding polyester urethane), polyester urethane, an ethylene-vinyl acetate copolymer, and a butyral resin. The component (E) may include at least one selected from the group consisting of polyester urethane and an ethylene-vinyl acetate copolymer from the viewpoint of easily lowering the reaction initiation temperature during thermal curing by light irradiation.

A content of the component (E) may be in the following range based on the total mass of the polymerizable composition from the viewpoint of easily lowering the reaction initiation temperature during thermal curing by light irradiation. The content of the component (E) may be 10.00 mass % or more, 15.00 mass % or more, 20.00 mass % or more, 25.00 mass % or more, 30.00 mass % or more, 35.00 mass % or more, 40.00 mass % or more, 45.00 mass % or more, or 50.00 mass % or more. The content of the component (E) may be 90.00 mass % or less, 85.00 mass % or less, 80.00 mass % or less, 75.00 mass % or less, 70.00 mass % or less, 65.00 mass % or less, 60.00 mass % or less, or 55.00 mass % or less. From these viewpoints, the content of the component (E) may be 10.00 to 90.00 mass %, 10.00 to 70.00 mass %, 10.00 to 60.00 mass %, 30.00 to 90.00 mass %, 30.00 to 70.00 mass %, 30.00 to 60.00 mass %, 40.00 to 90.00 mass %, 40.00 to 70.00 mass %, or 40.00 to 60.00 mass %.

The polymerizable composition of the present embodiment may contain a component other than the above-mentioned components. Examples of such a component include water, an organic solvent, a coupling agent, a filler, a softener, an accelerator, a deterioration inhibitor, a colorant, a flame retardant, and a thixotropic agent. The polymerizable composition of the present embodiment may contain at least one of these components, and may not contain at least one of these components.

The polymerizable composition of the present embodiment may be in the form of a film. A thickness of a film-shaped polymerizable composition or a thickness of a cured product of the present embodiment may be in the following range. The thickness may be 1 μm or more, 3 μm or more, 5 μm or more, 8 μm or more, 10 μm or more, 12 μm or more, 15 μm or more, 18 μm or more, or 20 μm or more. The thickness may be 500 μm or less, 300 μm or less, 200 μm or less, 100 μm or less, 80 μm or less, 50 μm or less, 30 μm or less, or 20 μm or less. From these viewpoints, the thickness may be 1 to 500 μm, 1 to 100 μm, 1 to 50 μm, 5 to 500 μm, 5 to 100 μm, 5 to 50 μm, 10 to 500 μm, 10 to 100 μm, or 10 to 50 μm.

### EXAMPLES

Hereinafter, the present disclosure will be further described using Examples and Comparative Examples, but the present disclosure is not limited to Examples below.

### <Synthesis of Urethane Acrylate (UA1)>

To a reaction vessel equipped with a stirrer, a thermometer, a reflux condenser having a calcium chloride drying tube, and a nitrogen gas introduction tube, 2500 parts by mass (2.50 mol) of poly(1,6-hexanediol carbonate) (trade name: DURANOL T5652, manufactured by Asahi Kasei Chemicals Corporation) and 666 parts by mass (3.00 mol) of isophorone diisocyanate (manufactured by Sigma-Aldrich Co. LLC) were uniformly added dropwise for 3 hours. Next, a sufficient amount of nitrogen gas was introduced into the reaction vessel, and then, the inside of the reaction vessel was heated to 70 to 75° C. for reaction. Next, 0.53 parts by mass (4.3 mmol) of hydroquinone monomethyl ether (manufactured by Sigma-Aldrich Co. LLC) and 5.53 parts by mass (8.8 mmol) of dibutyltin dilaurate (manufactured by Sigma-Aldrich Co. LLC) were added to the reaction vessel, 238 parts by mass (2.05 mol) of 2-hydroxyethyl acrylate (manufactured by Sigma-Aldrich Co. LLC) was added, and then, a reaction was performed at 70° C. for 6 hours in an air atmosphere. As a result, urethane acrylate (UA1) having a polycarbonate skeleton was obtained. The weight average molecular weight of the polyurethane acrylate (UA1) was 15000.

### <Synthesis of Polyester Urethane (EU1)>

48 parts by mass of isophthalic acid and 37 parts by mass of neopentyl glycol were added to a stainless steel autoclave with a heater equipped with a stirrer, a thermometer, a condenser, a vacuum generator, and a nitrogen gas introduction tube, and then, 0.02 parts by mass of tetrabutoxy titanate was added as a catalyst. Next, the temperature was raised to 220° C. under a nitrogen stream, and stirring was performed for 8 hours as it was. Thereafter, the pressure was reduced to atmospheric pressure (760 mmHg) and cooled to room temperature. As a result, a white precipitate was precipitated, and then, this precipitate was taken out. This precipitate was washed with water and then vacuum-dried to obtain a polyester polyol. This polyester polyol was sufficiently dried, then dissolved in MEK (methyl ethyl ketone), and added to a four-neck flask equipped with a stirrer, a dropping funnel, a reflux condenser, and a nitrogen gas introduction tube. In addition, dibutyltin dilaurate (catalyst) was added in an amount of 0.05 parts by mass with respect to 100 parts by mass of the polyester polyol, and 4,4′-diphenylmethane diisocyanate was dissolved in MEK in an amount of 50 parts by mass with respect to 100 parts by mass of the polyester polyol and added through a dropping funnel. Then, stirring was performed at 80° C. for 4 hours to obtain polyester urethane (EU1).

### <Preparation of Polymerizable Composition>

### Examples 1 and 2

A polymerizable composition was prepared by mixing a photoacid generator (a compound containing a sulfonium cation having three aryl groups bonded to a positively charged sulfur atom and (C₆F₅)₄B⁻ anion, trade name: CPI-410B, manufactured by San-Apro Ltd.), an acid component (phosphate having methacryloyl group, a phosphorus compound having a P═O(OH) structure, trade name: PM-21, manufactured by Nippon Kayaku Co., Ltd.), urethane acrylate (UA1), isocyanuric acid ethylene oxide-modified diacrylate (trade name: M-215, manufactured by Toagosei Co., Ltd.), dimethyloltricyclodecane diacrylate (trade name: Light Acrylate DCP-A, manufactured by Kyoeisha Chemical Co., Ltd.), a toluene solution of a polymerization initiator (diacyl peroxide, trade name: PEROYL L, manufactured by NOF CORPORATION) (solid content ratio: 20 mass %), a methyl ethyl ketone/toluene mixed solution (mass ratio: 1/1, solid content ratio: 40 mass %) of polyester urethane (EU1), and a toluene solution (solid content ratio: 30 mass %) of an ethylene-vinyl acetate copolymer (trade name: EV40W, manufactured by Du Pont-Mitsui Polychemicals Co., Ltd.). The amount (unit: parts by mass) of the photoacid generator is shown in Table 1. The amount of the acid component was 1.00 part by mass, the amount of the urethane acrylate (UA1) was 25.00 parts by mass, the amount of the isocyanuric acid ethylene oxide-modified diacrylate was 10.00 parts by mass, the amount of the dimethyloltricyclodecane diacrylate was 10.00 parts by mass, the amount (solid content) of the polymerization initiator was 5.00 parts by mass, the amount (solid content) of the polyester urethane (EU1) was 47.50 parts by mass, and the amount (solid content) of the ethylene-vinyl acetate copolymer was 7.50 parts by mass.

### Comparative Example 1

A polymerizable composition was prepared in the same manner as in Example 1 except that the photoacid generator was not used.

### <Preparation of Laminated Film>

The above-mentioned polymerizable composition was applied to a PET film (with peeling treatment: thickness: 50 μm) using a bar coater (trade name “KNIFE COATER SNC-300”, manufactured by Yasui Seiki Inc.), and then dried in an oven at 60° C. for 3 minutes, thereby preparing a laminated film having a 20 μm-thick film-shaped polymerizable composition disposed on the PET film.

### <Measurement of Reaction Initiation Temperature>

### (No Light Irradiation)

After the PET film was peeled off from the above-mentioned laminated film, a curing exothermic behavior of the film-shaped polymerizable composition was measured by differential scanning calorinetry (hereinafter, referred to as “DSC”), and an onset temperature of an exothermic peak was obtained as an index of the reaction initiation temperature of polymerization. DSC measurement was performed under the conditions below to obtain a reaction initiation temperature T1. The results thereof are shown in Table 1.

### [DSC Measurement Conditions]

Measuring apparatus: trade name “DSC8500”, manufactured by PerkinElmer Japan Co., Ltd.
Sample amount: 10.0±0.5 mg
Measurement temperature range: 25 to 200° C.
Heating rate: 30° C./min
Measurement atmosphere: nitrogen

### (With Light Irradiation)

The PET film was peeled off from the above-mentioned laminated film. Next, the film-shaped polymerizable composition was irradiated with ultraviolet rays (wavelength: 365 nm) at 25° C. for 5 seconds (irradiation intensity: 150 mW/cm²) using a fiber light source type LED spot UV irradiation device “SPOTCURE SPL-2” manufactured by USHIO INC., and then, the film-shaped polymerizable composition was allowed to stand at 25° C. for 5 minutes.

The curing exothermic behavior of the above-mentioned film-shaped polymerizable composition after light irradiation was measured by DSC, and an onset temperature of an exothermic peak was obtained as an index of the reaction initiation temperature of polymerization. DSC measurement was performed under the same conditions as those of the above-mentioned reaction initiation temperature T1 to obtain a reaction initiation temperature T2. In addition, a temperature difference (T2−T1) between the reaction initiation temperature T1 and the reaction initiation temperature T2 was calculated. The results thereof are shown in Table 1.

TABLE 1

| | | | | Comparative |
|---|---|---|---|---|
| | | Example | | Example |
| | | 1 | 2 | 1 |
| Photoacid | Amount [parts by mass] | 0.53 | 2.12 | 0 |
| generator | | | | |
| Reaction | T1: no light irradiation | 96.6 | 96.7 | 94.7 |
| initiation | T2: with light irradiation | 88.0 | 86.9 | 95.0 |
| temperature | Temperature difference | −8.6 | −9.8 | +0.3 |
| [° C.] | (T2 − T1) | | | |

1. A polymerizable composition comprising a polymerizable compound, the polymerizable composition comprising:
a photoacid generator and an acid component.

2. The polymerizable composition according to claim 1, wherein the photoacid generator includes a boron salt containing a borate anion.

3. The polymerizable composition according to claim 2, wherein the boron salt further contains a sulfonium cation.

4. The polymerizable composition according to claim 3, wherein the sulfonium cation has an aryl group bonded to a sulfur atom.

5. The polymerizable composition according to claim 1, wherein a content of the photoacid generator is 0.01 to 20.00 mass %.

6. The polymerizable composition according to claim 1, wherein the acid component includes a phosphorus compound.

7. The polymerizable composition according to claim 1, wherein the acid component includes a phosphorus compound having a P═O(OH) structure.

8. The polymerizable composition according to claim 1, wherein a content of the acid component is 0.01 to 10.00 mass %.

9. The polymerizable composition according to claim 1, wherein a mass ratio of a content of the acid component with respect to a content of the photoacid generator is 0.01 to 10.00.

10. The polymerizable composition according to claim 1, wherein the polymerizable compound includes a (meth)acrylate compound.

11. The polymerizable composition according to claim 1, further comprising an organic peroxide.

12. The polymerizable composition according to claim 2, wherein the acid component includes a phosphorus compound.

13. The polymerizable composition according to claim 2, further comprising an organic peroxide.

14. The polymerizable composition according to claim 1, wherein the photoacid generator includes a compound containing a borate anion.

15. The polymerizable composition according to claim 1, wherein the polymerizable compound includes a urethane (meth)acrylate compound having a structure derived from polycarbonate polyol.

16. The polymerizable composition according to claim 1, wherein the polymerizable compound includes an isocyanuric acid alkylene oxide-modified di(meth)acrylate.

17. The polymerizable composition according to claim 1, wherein the polymerizable compound includes a di(meth)acrylate compound having at least one selected from the group consisting of a dicyclopentanyl structure and a dicyclopentenyl structure.

18. The polymerizable composition according to claim 1, further comprising a diacyl peroxide.

19. The polymerizable composition according to claim 1, further comprising a thermoplastic resin.

20. The polymerizable composition according to claim 19, wherein the thermoplastic resin includes at least one selected from the group consisting of polyester urethane and an ethylene-vinyl acetate copolymer.
